(19) United States
(12) Patent Application Publication
(10) Pub. No.: US 2004/0189016 A1
(43) Pub. Date: Sep. 30, 2004

(54) Torque transmitting member and door lock device

(75) Inventors: Katsutoshi Fukunaga, Chiryu-shi (JP); Makoto Suzumura, Chita-shi (JP); Shigehiro Oya, Toyoake-shi (JP); Akira Muramatsu, Chiryu-shi (JP); Yukinobu Kunimatsu, Toyoake-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA

(21) Appl. No.: 10/742,772

(22) Filed: Dec. 23, 2003

(30) Foreign Application Priority Data
Dec. 24, 2002 (JP) 2002-372415

(51) Int. Cl. E05C 3/06

(52) U.S. Cl. 292/201

(57) ABSTRACT

A torque transmitting member, rotating around a first rotation center for transmitting a torque from a driving source to an output side member for rotating the output side member from a first position to a second position around a second rotation center differentiated from the first rotation center, includes a convex portion provided at a portion between the first rotation center and the second rotation center different from the first rotation center, the convex portion including a configuration extended in a radial direction and having an outer surface, and a contacting portion formed at the outer surface of the convex portion at the closest position to the first rotation center for always contacting the output side member at a predetermined position within a predetermined angle defined by a rotation of the output side member from the first position to the second position.

This application is based on and claims priority under 35 U.S.C. § 119 with respect to Japanese Patent Application No. 2002-372415 filed on Dec. 24, 2002, the entire contents of which are incorporated herein by reference.

### FIELD OF THE INVENTION

The present invention relates to a torque transmitting member and a door lock device. More particularly, the present invention pertains to a torque transmitting member for transmitting an inputted torque arid a door lock device applied with the torque transmitting member for switching a locked and unlocked state of a door.

### BACKGROUND OF THE INVENTION

A known torque transmitting member and a door lock device applied with the torque transmitting member are described in US5634677A.

As shown in FIG. 10, the known torque transmitting member described in US5634677A includes a driven member 91 including eccentric type control pins 90, 90. The driven member 91 rotates around a rotation center 92 by an input of the torque. When the driven member 91 is rotated, one of the eccentric type control pins 90, 90 contacts one of control surfaces 95, 95 at a fork receiving portion 94 of a central chain lock member 93 to rotate the central chain lock member 93 around an oscillation shaft 96. Thus, a locked state and an unlocked state of a vehicle door lock 97 serving as the door lock device is switched.

In order to increase the transmitting torque from the driven member 91 to the central chain lock member 93, it is desirable to determine a distance between the rotation center 92 and a contact point of the eccentric type control pin 90 contacting the control surface 95 short. Notwithstanding, with the known driven member 91, the contact point of the eccentric type control pin 90 is moved depending on the rotational position of the driven member 91 because the eccentric type control pins 90 is configured to be approximately circular. This brings the drawbacks that the transmission torque within a predetermined rotational angle of the driven member is varied and cannot be maintained large. Specifically, with the vehicle door lock 97, an output of an electric drive device for operating the driven member 91 has to be determined unnecessarily large.

A need thus exists for a torque transmitting member maintaining large transmission torque while reducing a size of an actuator of a door lock device.

### SUMMARY OF THE INVENTION

In light of the foregoing, the present invention includes a torque transmitting member rotating around a first rotation center for transmitting a torque from a driving source to an output side member for rotating the output side member from a first position to a second position around a second rotation center differentiated from the first rotation center, which includes a convex portion provided at a portion between the first rotation center and the second rotation center different from the first rotation center, the convex portion including a configuration extended in a radial direction and having an outer surface, and a contacting portion formed at the outer surface of the convex portion at the closest position to the first rotation center for always contacting the output side member at a predetermined position within a predetermined angle defined by a rotation of the output side member from the first position to the second position.

According to another aspect of the present invention, a door lock device includes an actuator, a rotation member rotating around a first rotation center by an actuation of the actuator, a convex portion provided at a portion of the rotation member other than the first rotation center, a locking and unlocking member moving between a locked position at which an operation of an opening operation member being not transmitted to a door close maintaining means and an unlocked position at which the operation of the opening operation member being transmitted to the door close maintaining means by a rotation of the rotation member, the convex portion including a configuration extended in a radial direction and having an outer surface, and a contacting portion formed at the outer surface of the convex portion at the closest position to the first rotation center for always contacting the locking and unlocking member at a predetermined position within a predetermined angle defined by a rotation of the locking and unlocking member from a locked position to an unlocked position and from the locked position to the unlocked position.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a plane view of a latch mechanism of a door lock device according to an embodiment of the present invention.

FIG. 2 is a plane view of a lock mechanism of the door lock device according to the embodiment of the present invention.

FIG. 3 is a view for explaining an operation of a torque transmitting member and an output side member according to the embodiment of the present inventions.

FIG. 4 is a view for explaining the operation of the torque transmitting member and the output side member according to the embodiment of the present inventions.

FIG. 5 is a view for explaining the operation of the torque transmitting member and the output side member according to the embodiment of the present inventions

FIG. 6 is a view for explaining the operation of the torque transmitting member and the output side member according to the embodiment of the present inventions

FIG. 7 is a view for explaining details of the operation of the torque transmitting member and the output side member according to the embodiment of the present inventions

FIG. 8 is a view for explaining an operation of a comparative torque transmitting member and an output side member.

FIG. 9 is a view for explaining the operation of the comparative torque transmitting member and the output side member.

FIG. 10 is a view showing a known door lock device.

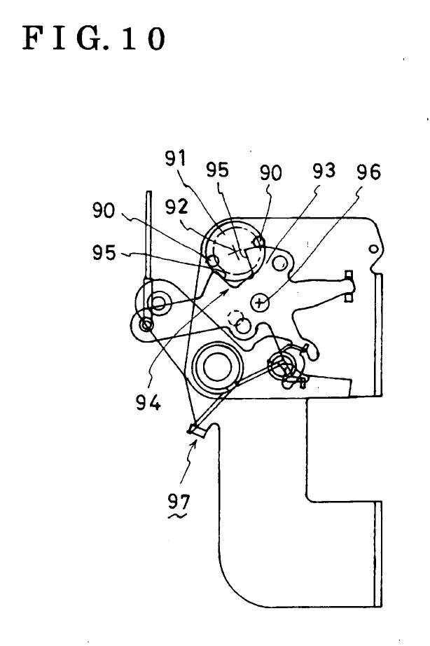

### DETAILED DESCRIPTION OF THE INVENTION

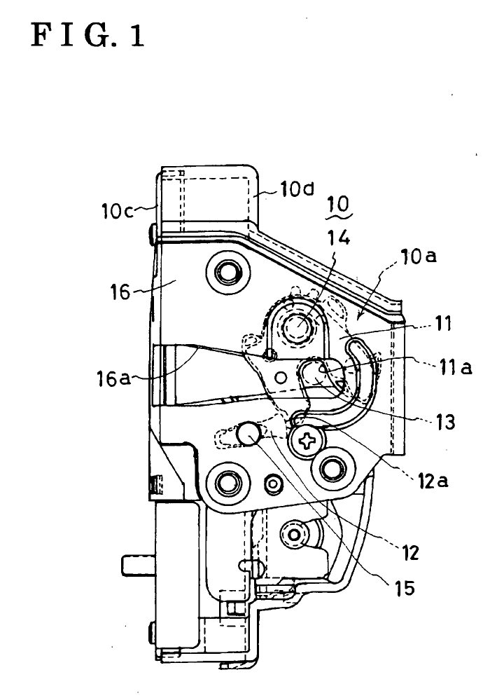

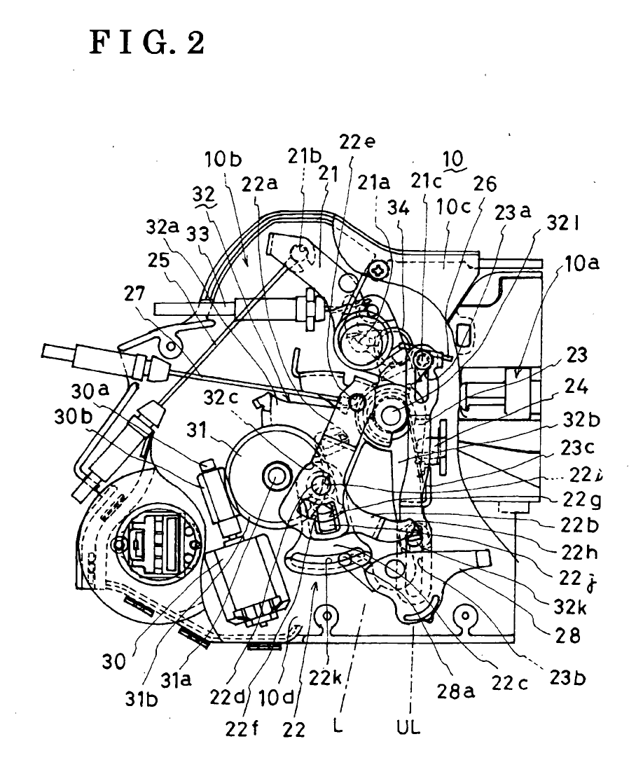

One embodiment of the present invention will be explained with reference to drawing figures as follows. A door lock device 10 serving as a door lock device includes a latch mechanism 10a serving as a means for maintaining a door closed (shown in FIG. 1) and a lock mechanism 10b (shown in FIG. 2). The door lock device 10 further includes a cover 10c covering the latch mechanism 10a and the lock mechanism 10b from left side of FIG. 1 and a housing 10d covering the latch mechanism 10a and the lock mechanism 10b from the right side of FIG. 1. The construction of the latch mechanism 10a will be explained in details referring to FIG. 1 as follows. The latch mechanism 10a includes a latch 11 and a pawl 12. The latch 11 is supported rotatably relative to a latch shaft 14. The latch 11 includes an engaging groove 11a for engagingly maintaining a striker 13 provided on a vehicle body therein at a rotational position shown in FIG. 1. The pawl 12 is supported rotatably relative to a pawl shaft 15. The pawl 12 includes a contacting portion 12a contacting the latch 11 at the rotational position shown in FIG. 1 for restricting the rotation of the latch 11 in the clockwise direction of FIG. 1.

The operation of the latch mechanism 10a will be explained as follows. FIG. 1 shows a latched state wherein the door is maintained closed relative to the vehicle body. When the pawl 12 rotates around the pawl shaft 15 at the latched state by a predetermined angle in the clockwise direction, the contacting portion 12a of the pawl 12 is disengaged from the latch 11. Thus, the latch 11 rotates in the clockwise direction of FIG. 1 by a biasing force of a spring so that the engaging groove 11a assumes to correspond to a recess portion 16a formed at a base 16. With this state, the striker 13 can be disengaged from the engaging groove 1 la in the left direction of FIG. 1 to assume the unlatched state wherein the door can be opened relative to the body. The details of the lock mechanism 10b will be explained with reference to FIG. 2. FIG. 2 viewing the door lock device 10 from the left side of FIG. 1 does not show a portion of the cover 10c for the explanatory purpose.

The lock mechanism 10b includes an open system operation member and a lock system operation member. The open system operation member operates the latch 11 based on the operation of an outside handle provided outside of the vehicle door and an inside handle provided interior of the vehicle, or the like, to open the door relative to the body. The lock system operation member switches the unlocked state at which the latch 11 is operable in accordance with the operation of the outside handle, or the like and the locked state at which the latch 11 is inoperable in accordance with the operation of the outside handle, or the like.

The open system operation member includes an outside open lever 21 servings as an opening operation member, an inside open lever 22 serving as the opening operation member, an open link 23, and a lift lever 24.

The outside open lever 21 is rotatable around a pin 21a to be supported by the cover 10c. The outside open lever 21 is formed with a connection recess 21b on a first end and a connection shaft 21c on a second end. The connection recess 21b is connected to a cable 25 linking to the outside handle. The outside open lever 21 rotates around the pin 21a in the counterclockwise direction of FIG. 2 based on the operation of the outside handle. In this case, the connection shaft 21c moves approximately upward of FIG. 2. Because the connection shaft 21c is engaged with a spring 26, the outside open lever 21 rotates in the clockwise direction of FIG. 2 to return to the position shown in FIG. 2 by the biasing force of the spring 26 when the operation of the outside handle returns.

The inside open lever 22 includes a first inside open lever 22a, a second inside open lever 22b, and an intermediate lever 22c. The first inside open lever 22a, the second inside open lever 22b, and the intermediate lever 22c are rotatably supported at the cover 10c about a pin 22d. The first inside open lever 22a is formed with a connection bore 22e at a first end and a bore 22f with anomalous line at a second end. The connection bore 22e is connected with a cable 27 linking to the inside handle. The second inside lever 22b includes a long bore 22g and an engaging end portion 22h. The intermediate lever 22c includes a long bore 22i, an engaging projection 22j, and an arc bore 22k. The engaging projection 22j is located through the long bore 22g of the second inside lever 22b and the bore 22f with anomalous line of the first inside lever 22a. A connection shaft 28a of a child protector lever 28 rotatably supported by the cover 10c is located through the arc bore 22k. When the child protector lever 28 rotates, the intermediate lever 22c moves upward and downward of FIG. 2. At the movement of the child protector lever 28, the engaging projection 22j relatively moves in the long bore 22g and the bore 22f with anomalous line and the pin 22d relatively moves in the long bore 22i.

When the intermediate lever 22c is positioned at a position shown in FIG. 2 (i.e., child protector unset state), the entire inside open lever 22 rotates in the counterclockwise direction of FIG. 2 about the pin 22d based on the operation of the inside handle. When the intermediate lever 22c is moved upward of FIG. 2 to locate the engaging projection 22j at a top end of the long bore 22g (i.e., child protector set state), the engaging projection 22j loses the motion in the bore 22f with anomalous line even if the first inside open lever 22a rotates based on the operation of the inside handle. In other words, the intermediate lever 22c and the second inside open lever 22b do not rotate at the child protector set state.

The open link 23 includes connection long bores 23a, 23b at first and second ends and a flange 23c having approximately L-shaped cross-section. The connection shaft 21c of the outside open lever 21 is positioned in the connection long bore 23a. Accordingly, when the outside open lever 21 rotates in the counterclockwise direction about the pin 21a, the open link 23 moves upward of FIG. 2. When the entire inside open lever 22 rotates in the counterclockwise direction of FIG. 2 about the pin 22d, the engaging end portion 22h of the second inside open lever 22b engages with the flange 23c. Thus, the open link 23 moves approximately upward of FIG. 2.

At a state (i.e., unlocked state) when the open link 23 is positioned at an unlock position (i.e., UL of FIG. 2), the flange 23c engages with the lift lever 24 by the upward movement of the open link 23 to move the lift lever 24 upward of FIG. 2. The lift lever 24 is unitarily and rotatably- supported at the pawl shaft 15 of the pawl 12. When the lift lever 24 moves upward of FIG. 2, the pawl 12 rotates in the clockwise direction of FIG. 1 to switch the latch mechanism 10a from the latched state to the unlatched state. The open link 23 transmits the rotational operation of the outside open lever 21 and the inside open lever 22 to the latch mechanism 10a at the unlocked state.

The lock system member of the lock mechanism 10b includes a motor 30 serving as an actuator, a wheel gear 31 serving as a torque transmitting member and a rotation member, and an active lever 32 serving as an output side member and a locking and unlocking member.

The motor 30 is fixed to the housing 10d and drives by the energization to rotate a warm gear 30b provided at an output shaft 30a around an output shaft 30a. The circular wheel gear 31 is supported by the housing 10d rotatably around a rotation shaft 31a serving as a first rotational center. The wheel gear 31 includes a gear teeth 31b geared with the warm gear 30b at an external periphery thereof. The wheel gear 31 rotates in the clockwise direction and the counterclockwise direction of FIG. 2 depending on the input of the torque from the motor 30. The wheel gear 31 includes two convex portions 31c, 31c at an eccentric position from the rotation shaft 31a to be projected in the depth direction of FIG. 2. The convex portions 31c, 31c revolve around the rotation shaft 31a at the rotation of the wheel gear 31.

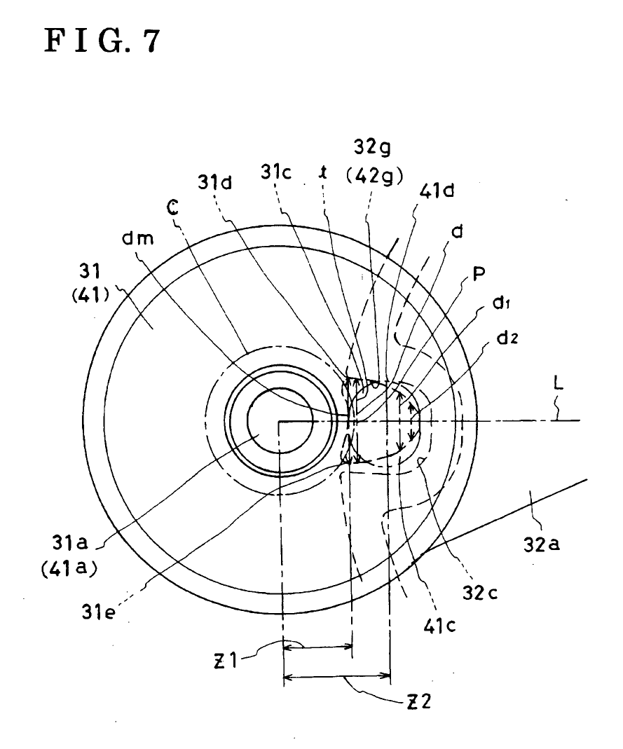

The configuration of the convex portion 31c will be explained with reference to FIG. 2 and FIG. 7. As shown in FIG. 7, the convex portion 3c is configured to be symmetric relative to a reference line L serving as a reference line penetrating through the rotation shaft 31a and the convex portion 31c. The reference line L penetrating through the rotation shaft 31a and the convex portion 31c corresponds to the line penetrating through either the center of the gravity or the center of figure of the rotation shaft 31a and the convex portion 31c respectively. A width d (serving as a width) in the direction of a tangential line t (serving as a tangential line) of a circle C (serving as a circle) having the rotation shaft 31a at the center at a point P (serving as a arbitrary point) on the reference line L is determined to be larger at the rotation shaft 31a side. In other words, as shown in FIG. 7, a width d1 positioned at the rotation shaft 31a side is determined to be larger than a widths d2. A first contact portion 31d (serving as a contact portion) and a second contact portion 31e (serving as the contact portion) are provided at an external positions constructing the maximum value dm of the convex portion 31c.

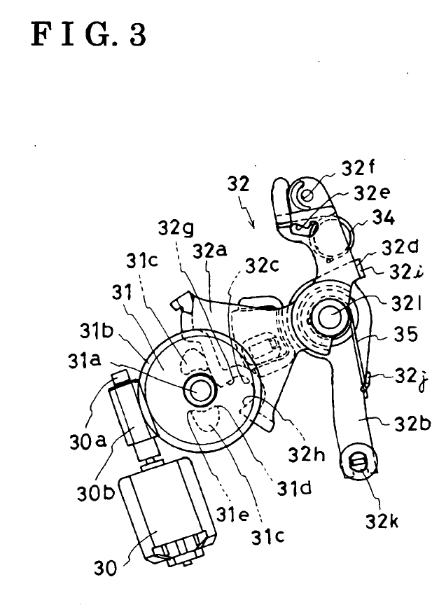

The configuration of the active lever 32 will be explained with reference to FIGS. 2-3 as follows. The active lever 32 includes a resin lever 32a, a metal lever 32b, and a pin 32c serving as a second rotational center rotatably supporting the resin lever 32a and the metal lever 32b relative to the housing 10d. The resin lever 32a includes a recess portion 32c, a pressurizing portion 32d, a bore 32e with anomalous line, and a connection bore 32f. The recess portion 32c includes a first engaging surface 32g and a second engaging surface 32h.

When the wheel gear 31 rotates, the convex portion 31c is engaged with the recess portion 32c. When the convex portion 31 contacts the engaging surface 32g of the recess portion 32c, the resin lever 32a rotates around the pin 32c in the clockwise direction of FIG. 3. When the convex portion 31c contacts the engaging surface 32h of the recess portion 32c, the resin lever 32a rotates around the pin 32c in the counterclockwise direction of FIG. 3. Details of the operation win be explained hereafter. A cable 33 (shown in FIG. 2) linked to a lock knob provided at the interior of the door is connected to the connection bore 32f of the resin lever 32a. The resin lever 32a is also rotated around the pin 32c based on the operation of the lock knob. The bore 32e with anomalous line is provided with a positioning spring 34. A first end of the positioning spring 34 is engaged with the bore 32e with anomalous line and a second end of the positioning spring 34 is engaged with the housing 10c. The resin lever 32a is selectively positioned at the unlocked position and the locked position by the biasing force of the positioning spring 34.

The metal lever 32b includes a first flange 32i, a second-flange 32j, and a boss 32k. The pressurizing portion 32d of the resin lever 32a contacting the flange 32i of the metal lever 32b pushes the first flange 32i, when the torque is applied to the resin lever 32a to rotate around the pin 32c in the clockwise direction of FIG. 3, to rotate the entire active lever 32. A spring 35 coiled around the pin 32c is provided between the resin lever 32a and the metal lever 32b. A first end of the spring 35 is engaged with the resin lever 32a and a second end of the spring 35 is engaged with the flange 32j of the metal lever 32b. Thus, when the torque is applied to rotate the resin lever 32a in the counterclockwise direction of FIG. 3 about the pin 32c, the entire active lever 32 is rotated by the biasing force of the spring 35.

As shown in FIG. 2, the boss 32k of the metal lever 32b is connected to the connection long bore 23b of the open link 23. Thus, when the entire active lever 32 rotates around the pin 32c in the clockwise direction of FIG. 3 at the unlocked state, the open link 23 rotates by a predetermined angle in the clockwise direction of FIG. 2 around the connection shaft 21c of the outside open lever 21 from the unlocked position to the locked position (i.e., L of FIG. 2). That state is defined as a locked state of the door lock device 10.

At the locked state wherein the open link 23 is positioned at the locked position, the flange 23c swings, or does not contact relative to the lift lever 24 despite the movement of the open link 23 in the upward direction of FIG. 2 by the rotation of the outside open lever 21 and the inside open lever 22. In other words, the open link 23 cannot transmit the rotational operation of the outside open lever 21, or the like, to the latch mechanism 10a at the locked state. Accordingly, the latch mechanism 10a cannot be switched from the latched state to the unlatched state even by the rotation of the outside open lever 21, or the like, at the locked state.

The operation of the active lever 32 based on the rotation of the wheel gear 31 will be explained with reference to FIGS. 3-9.

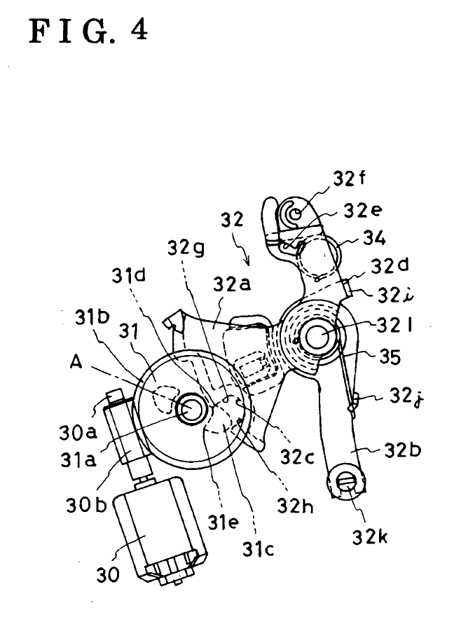

FIG. 3 shows the active lever 32 at the unlocked state. This position of the active lever 32 is defined as an unlocked position of the active lever 32. By inputting the torque to the wheel gear 31 at the unlocked position of the active lever 32 by driving the motor 30 in a first direction, the wheel gear 31 rotates counterclockwise of FIG. 3 so that the contact portion 31d of the convex portion 31c contacts the engaging surface 32g of recess portion 32c as shown in FIG. 4. The rotational position of the wheel gear 31 shown in FIG. 4 is defined as a position A.

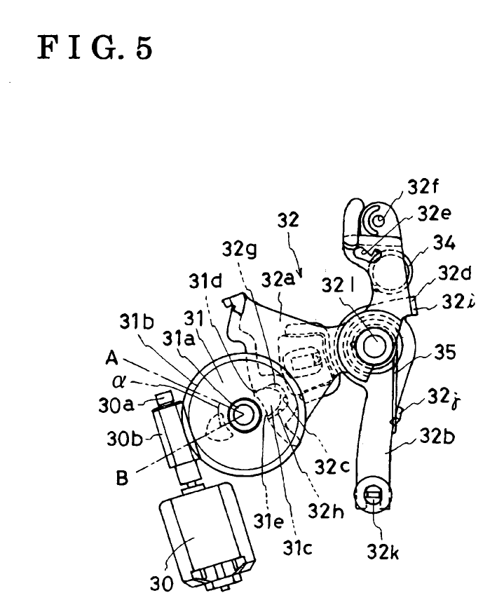

By further rotating the wheel gear 31 counterclockwise of FIG. 4 at the state shown in FIG. 4, the contact portion 31d keeps contacting and pushing the engaging F surface 32g to rotate the active lever 32 to be a state shown in FIG. 5. A rotational position of the wheel gear 31 shown in FIG. 5 is defined as a position B. In this case, the contact portion 31d is positioned at the external peripheral of the convex portion 31c configuring the maximum value dm of the width d. Thus, the contact portion 31d always contacts the engaging surface 32g of the active lever 32 irrespective of the rotational position of the wheel gear 31 within a predetermined angle a determined by the rotation of the wheel gear 31 from the position A to the position B. Because the contact portion 31d is formed at a position close to the rotation shaft 31a at the convex portion 31c, the distance between the rotation shaft 31a and the contact portion 31d can be maintained short within the angle α. Accordingly, the transmitting torque from the wheel gear 31 to the active gear 32 can be maintained large.

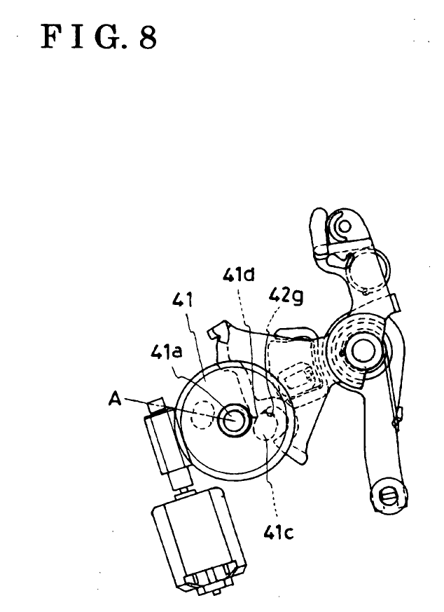

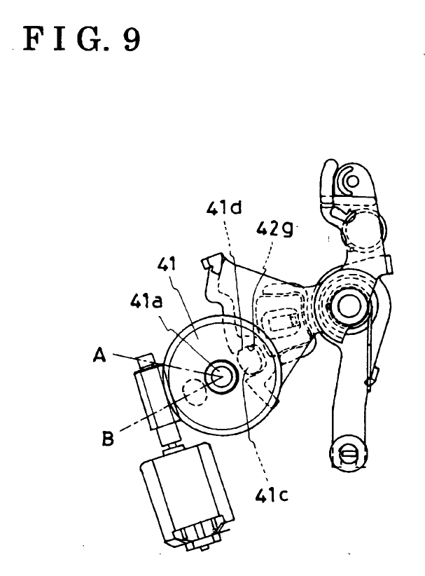

In order to explain the construction of the foregoing embodiment of the present invention, a comparative example shown in FIGS. 8-9 is provided. The example shown in FIG. 8 corresponds to the embodiment illustrated in FIG. 4 and the example shown in FIG. 9 corresponds to the embodiment illustrated in FIG. 5. As shown in FIGS. 8-9, a convex portion 41c of a wheel gear 41 is configured to be approximately circular. When the wheel gear 41 rotated from a position A of FIG. 8 to a position B of FIG. 9, a position of a contact portion 41d contacting an engaging surface 42g at the convex portion 41c is changed. FIG. 7 shows the contacting state between the convex portion 31c and the engaging surface 32g shown in FIG. 5 and the contacting state between the convex portion 41c and the engaging surface 42g of FIG. 9. As shown in FIG. 7, a distance Z1 between the rotation shaft 31a and the contacting portion 31d is determined to be shorter than a distance Z2 between the rotation shaft 41a and the contacting portion 41d. Thus, the transmitting torque from the wheel gear 31 to the active lever 32 can be maintained large.

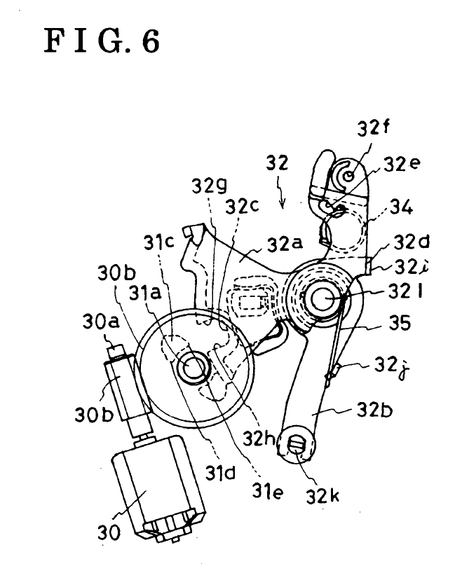

By further rotating the wheel gear 31 shown in FIG. 5 in the counterclockwise direction, the convex portion 31c is disengaged from the recess portion 32c as shown in FIG. 6. The active lever 32 is positioned at a locked position and the open link 23 is positioned at the locked position (the position L shown in FIG. 2).

When the torque is inputted to the wheel gear 31 by driving the motor 30 in a second direction at the state shown in FIG. 6, the wheel gear 31 rotates clockwise of FIG. 6. The contacting portion 31e of the convex portion 31c contacts the engaging surface 32h of the recess portion 32c to rotate the active lever 32 counterclockwise of FIG. 6. The active lever 32 returns to the state shown in FIG. 3 in the foregoing manner. Because the contacting portion 31e keeps contacting the engaging surface 32h irrespective of the rotational position of the wheel gear 31 within the predetermined rotation angle of the wheel gear 31, the transmitting torque from the wheel gear 31 to the active lever 32 can be maintained large with the operation when the motor 30 rotates in the second direction.

With the door lock device 10 of the embodiment of the present invention, because the transmitting torque from the wheel gear 31 to the active gear 32 can be maintained large, the output of the motor 30 for rotating the wheel gear 31 can be determined small, which enables to reduce the size of the motor 31. Although the active lever 32 includes the recess portion 32c in the foregoing embodiment, the recess portion 32c may not be included.

Although the convex portion 31c projects perpendicular to the rotational plane surface of the wheel gear 31 with the foregoing embodiment, the convex portion 31c may project in the direction of the rotational plane surface of the wheel gear 31. According to the embodiment of the present invention, the contacting portion formed close to the first rotation center corresponding to the rotational center of the torque transmitting member contacts the output side member irrespective of the rotational position within the predetermined rotation angle. Thus, the distance between the first rotational center and the contacting portion can be maintained short and the transmitting torque from the torque transmitting member to the output side member can be maintained large.

According to the embodiment of the present invention, the widths of the convex portion at the first rotation center side is determined to be large. And the contacting portion contacts the external surface of the convex portion constructing the maximum value of the width. Accordingly, when the torque transmitting member rotates within the predetermined rotation angle, the external surface of the convex portion with the maximum width serving as the contacting portion contacts the output side member. Thereafter, the contacting portion keeps contacting the output side member even after further rotation of the torque transmitting member.

According to the embodiment of the present invention, the contacting portion formed close to the first rotation center corresponding to the rotational center of the rotation gear contacts the operation member irrespective of the rotational position within the predetermined rotation angle. Accordingly, the distance between the first rotation center and the contacting portion can be maintained short and the transmitting torque from the rotation member to the operation member can be maintained large. Thus, the actuator for operating the rotation member is not necessary to be determined unnecessarily large and the size of the actuator can be reduced.

The principles, preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A torque transmitting member rotating around a first rotation center for transmitting a torque from a driving source to an output side member for rotating the output side member from a first position to a second position around a second rotation center differentiated from the first rotation center comprising:
a convex portion provided at a portion between the first rotation center and the second rotation center different from the first rotation center, the convex portion including a configuration extended in a radial direction and having an outer surface; and
a contacting portion formed at the outer surface of the convex portion at the closest position to the first rotation center for always contacting the output side member at a predetermined position within a predetermined angle defined by a rotation of the output side member from the first position to the second position.

2. The torque transmitting member according to claim 1, wherein
the configuration of the convex portion shaped in the approximately triangular shape including a width in a tangent direction of an imaginary circle having the first rotation center as the center varying depending on an arbitrary point on a reference line penetrating through the first rotation center; wherein
the width in the tangent direction is configured to be longer as the arbitrary point is closer to the first rotation center; and wherein
the contacting portion is positioned at a portion of the outer surface of the convex portion including a maximum length of the width in the tangent direction.

3. A door lock device comprising:
an actuator;
a rotation member rotating around a first rotation center by an actuation of the actuator;
a convex portion provided at a portion of the rotation member other than the first rotation center;
a locking and unlocking member moving between a locked position at which an operation of an opening operation member being not transmitted to a door close maintaining means and an unlocked position at which the operation of the opening operation member being transmitted to the door close maintaining means by a rotation of the rotation member;
the convex portion including a configuration extended in a radial direction and having an outer surface; and
a contacting portion formed at the outer surface of the convex portion at the closest position to the first rotation center for always contacting the locking and unlocking member at a predetermined position within a predetermined angle defined by a rotation of the locking and unlocking member from a locked position to an unlocked position and from the locked position to the unlocked position.

4. The door lock device according to claim 3, wherein
the configuration of the convex portion shaped in the approximately triangular shape including a width in a tangent direction of an imaginary circle having the first rotation center as the center varying depending on an arbitrary point on a reference line penetrating through the first rotation center; wherein
the width in the tangent direction is configured to be longer as the arbitrary point is closer to the first rotation center; and wherein
the contacting portion is positioned at a portion of the outer surface of the convex portion including a maximum length of the width in the tangent direction.

5. The door lock device according to claim 4, further comprising:
a recess portion formed at the locking and unlocking member; and
a pair of engaging surfaces formed at the recess portion and extended in a radial direction, the engaging surfaces contacting the contacting portion.
